(19) United States
(12) Patent Application Publication
(10) Pub. No.: US 2007/0244238 A1
(43) Pub. Date: Oct. 18, 2007

(54) Polymer dispersions, process for the preparation thereof and the use thereof

(75) Inventors: Ulrich Desor, Idstein (DE); Stephan Krieger, Hofheim (DE)

Correspondence Address: CONNOLLY BOVE LODGE & HUTZ, LLP, P O BOX 2207, WILMINGTON, DE, 19899, US

(73) Assignee: Celanese Emulsions GmbH, Kronberg/Ts. (DE)

(21) Appl. No.: 11/726,822

(22) Filed: Mar. 23, 2007

(30) Foreign Application Priority Data
Mar. 25, 2006 (DE) 10 2006 013 898.8

(51) Int. Cl. C08K 5/06

(52) U.S. Cl. 524/366; 524/502; 524/523; 524/460

(57) ABSTRACT

Polymer dispersions, processes for the preparation thereof and the use thereof

Polymer dispersions containing at least two copolymers A and B in a weight ratio of from 5:95 to 95:5 are described, the glass transition temperatures T_{g} of the copolymers A and B differing by at least 10° C., and at least one nonionic emulsifier from the group consisting of the aryl-substituted phenolalkyleneoxy ethers. From these polymer dispersions, it is possible to formulate, for example, coatings, glazes and paints for coating substrates of all types. The polymer dispersions are distinguished by a very good shear stability and can be applied in particular by spray application.

Polymer dispersions, processes for the preparation thereof and the use thereof

The present invention relates to novel polymer dispersions which form films having high blocking resistance and scratch resistance and have sufficient resilience for applications on substrates which do not have dimensional stability.

The production of aqueous coatings which can be applied to substrates which do not have dimensional stability, for example of wood varnishes, glazes and gloss paints, requires binders which have sufficient resilience so that cracking on weathering of the coating does not occur.

Furthermore, however, these coatings are required to have a certain hardness so that the coating possesses good scratch resistance and blocking resistance. For ecological reasons, film formation of the binder in the range of from 0 to 40° C. is desirable, so that no film consolidating agent or only small amounts thereof is or are required.

DE-A-1,220,613 already describes so-called multi-stage polymers, also referred to as heterogeneous dispersions or core-shell dispersions, derived from (meth)acrylates and vinyl monomers. This technology is used for preparing blocking-resistant dispersions which simultaneously have a low film formation temperature (also referred to below as minimum film formation temperature or “MFT”).

By choosing suitable crosslinking agents and monomer mixtures, as described in EP-A-184,091, EP-A-15,644 and EP-A-795,568, it was possible further to improve the property profile of multistage polymers with regard to blocking resistance, elongation at break and scratch resistance for applications in paints and coatings. Thus, EP-A-184,091 and EP-A-15,644 discloses that aqueous self-crosslinking polymer dispersions which have a low MFT and form films having high blocking resistance can be prepared by multistage emulsion polymerization. As a result of the use of a relatively high proportion of soft monomers in the first stage, however, the corresponding polymer films have deficiencies with regard to the scratch resistance.

In addition to multistage polymers having film formation temperatures below room temperature, EP-A-332,011 also describes systems having a film formation temperature of >65° C. Furthermore, EP-A-429,207 describes corresponding dispersions having particles sizes in the range of 20-70 nm.

The multistage polymers disclosed in EP-A-332,011 have an MFT in the range of from 65 to 110° C. These dispersions form very scratch-resistant films that require a large amount of film consolidating agent when used as the sole binder. Furthermore, the elongation at break of the corresponding coating films is frequently insufficient for application to substrates which do not have dimensional stability.

EP-A-1,370,621 discloses aqueous dispersions containing multistage polymers which are stabilized with ionic emulsifiers and optionally with nonionic emulsifiers. Nonionic emulsifiers, if present at all, are used in a less than theoretically required amount. Ethoxylated mono-, di- and trialkyl phenols are described as typical members of nonionic emulsifiers. The aqueous dispersions are distinguished by improved blocking resistance of the films formed therefrom.

EP-A-349,383 discloses the use of aryl-substituted phenolalkyleneoxy ethers in polymer dispersions for producing polymer latices having a low content of polymerization residues. This document provides no information about the improvement of the shear stability of the dispersions by the use of these emulsifiers.

For the preparation of multistage polymers, as a rule at least two monomer emulsions are polymerized in succession so that the final multistage dispersion contains at least two polymer phases which may be arranged differently in the particle. Furthermore, the so-called powerfeed process is also known.

In emulsion polymerization, usually one or more emulsifiers are used. Depending on the monomer combinations used in each case, usually nonionic and/or anionic emulsifiers are used.

For dispersions which are used as binders in coatings or glazes, in addition to the good performance characteristics of the films formed therefrom it is particularly important that dispersions are stable to shearing. The processing of these dispersions is frequently effected by spray application. In this case shear stress at the nozzle and, in the case of poor shear stability, coagulum formation and hence blockage of the nozzles occurs.

Typical members of nonionic emulsifiers used to date are alkoxylated alcohols or alkoxylated alkylphenols. Very recently, attempts have been made to avoid so-called alkylphenol ethoxylates (also referred to below as “APEO”) as nonionic emulsifiers since they are suspected of having a hormonal effect and giving rise to the risk of malformations in the development of organisms.

It is an object of the present invention to provide dispersions which contain no APEO or only small proportions of APEO and which can be readily processed by spray application, which form films at temperatures of from 0 to 40° C. and give films having excellent blocking resistance and scratch resistance and having sufficient resilience and which are suitable for the coating of substrates which do not have dimensional stability.

A further object of the present invention is to provide dispersions which contain no APEO or only small proportions of APEO and which are suitable in particular for the preparation of wood varnishes, glazes and gloss paints.

Yet another object of the present invention is the provision of an APEO-free emulsifier which ensures the desired shear stability of multistage polymer dispersions but does not adversely affect the blooming and the water resistance of the dispersion.

The present invention relates to a polymer dispersion containing at least two copolymers A and B in a weight ratio of from 5:95 to 95:5, preferably from 30:70 to 70:30, particularly preferably from 40:60 to 60:40, the glass transition temperatures T_{g} of the copolymers A and B differing by at least 10° C., preferably by at least 20° C. and, particularly preferably by at least 30° C., and at least one nonionic emulsifier from the group consisting of the aryl-substituted phenolalkyleneoxy ethers.

The copolymers A and B used according to the invention may be present as physical mixtures or preferably as multistage polymers. The multistage polymerization may begin with the preparation of the copolymer A followed by the preparation of the copolymer B or the converse sequence of preparation may also be chosen.

The multistage polymer preferably used according to the invention is derived from the emulsion polymerization of at least two monomer mixtures which have the composition stated above for the first phase (monomer mixture I) and for the second phase (monomer mixture II).

In the case of the mixture of the copolymers A and B which is used according to the invention, said copolymers are prepared in separate batches of monomer mixture I and monomer mixture II by emulsion polymerization and then mixed with one another.

The weight ratio of monomer mixture I to monomer mixture II and hence of the first phase to the second phase or of the first copolymer and the second copolymer is from 5:95 to 95:5, preferably from 30:70 to 70:30, particularly preferably from 40:60 to 60:40, based on the monomers A band B of the respective stage.

The choice of the monomers of the respective stages can in principle be arbitrary, provided that the resulting copolymers differ in the glass transition temperature by at least 10° C. The establishment of a certain glass transition temperature through the choice of the monomers is known to the person skilled in the art; for example, the glass transition temperature can be calculated on the basis of the Fox-Flory equation. In the context of this description, glass transition temperatures are to be understood as meaning the values determined according to DSC (at a heating rate of 10 K/min).

The monomer mixtures I and II are usually chosen so that a copolymer A having glass transition temperatures of from −60 to 30° C. forms and that a copolymer B having glass transition temperatures of from 30 to 120° C. forms, preferably a copolymer A having glass transition temperatures of from −40 to 20° C. and a copolymer B having glass transition temperatures of from 45 to 115° C.

For the preparation of the aqueous polymer dispersions according to the invention by emulsion polymerization, mixtures of any desired ethylenically unsaturated monomers capable of undergoing free radical polymerization may be used.

These are preferably monomer mixtures containing acrylates and/or methacrylates and/or vinylaromatics and/or vinyl esters as main monomers. The use of monomer mixtures containing acrylates and/or methacrylates and/or vinylaromatics is particularly preferred.

Main monomers are usually present in amounts of from 70 to 99.9% by weight, based on the total amount of the monomers used in the copolymerization.

In addition to the main monomers, small proportions of monomers having stabilizing groups, such as acid or amido groups, are used. The amounts thereof are usually from 0.1 to 10% by weight, preferably from 0.2 to 5.0% by weight, based on the total amount of the monomers used in the copolymerization.

In addition to the main monomers and the monomers having stabilizing groups, further monomers may optionally be used. These are the groups consisting of the monomers containing keto groups and the other monomers. The amounts thereof are usually in each case from 0.0 to 10% by weight, preferably from 0.0 to 5.0% by weight, based on the total amount of the monomers used in the copolymerization.

Particularly preferably used monomer mixtures are those having the following composition:
a) from 85 to 99.8% by weight of acrylates of C₁ to C₂₀ alkanols, methacrylates of C₁ to C₁₂ alkanols and/or vinylaromatic monomers and/or vinyl esters of saturated C₁-C₆ carboxylic acids,
b) from 0.2 to 5% by weight of monomers having stabilizing groups, such as copolymerizable carboxylic acids, copolymerizable carboxamides, copolymerizable phosphates and/or phosphonates, copolymerizable sulfates and/or copolymerizable sulfonic acids and/or salts thereof,
c) from 0 to 10% by weight of monomers having keto groups and
d) from 0 to 10% by weight of other monomers.

The monomer mixtures are chosen in the individual case in such a way that the copolymer having the desired glass transition temperature forms.

Preferably used monomers a) are acrylates and methacrylates of C₁ to C₂₀ mono alcohols, such as, for example, ethyl acrylate, butyl acrylate, n-octyl acrylate, 2-ethylhexyl acrylate, methyl methacrylate, butyl methacrylate, cyclohexyl methacrylate, isobornyl methacrylate, and/or vinylaromatic monomers such as, for example, styrene or vinyltoluene, and/or vinyl acetate.

If the multistage emulsion polymerization process is employed, the monomers imparting hardness and the plasticizing monomers and the mass ratio of the individual polymerization stages are preferably combined so that the dispersion has a minimum film formation temperature in the range of from 0 to 80° C., preferably from 0 to 50° C., and the corresponding dispersion films have an elongation at break of >100% at a film thickness of 100 μm.

Preferably used monomers having stabilizing groups b) are copolymerizable carboxylic acids and carboxamides, such as acrylic acid, methacrylic acid, itaconic acid, acrylamide and methacrylamide, and/or copolymerizable sulfates and/or copolymerizable sulfonates, such as sodium ethenesulfonate, sulfoalkyl (meth)acrylates, e.g. potassium salt of sulfopropyl methacrylate (=SPM® from Raschig), sulfoalkyl(meth)acrylamides, e.g. the sodium salt of acrylamido-2-methylpropanesulfonic acid (=AMPS® from Lubrizol).

In addition, phosphates and/or phosphonates modified with groups capable of undergoing free radical polymerization can be used as monomers having stabilizing groups b). Examples of these are vinyl phosphonates or the abovementioned alcohol ether phosphates modified by copolymerization with phosphate and/or phosphonate groups.

Monomers containing acetoacetoxy groups, e.g. acetoacetoxy ethyl methacrylate, acetoacetoxybutyl methacrylate, acrylamidomethylacetylacetone and vinyl acetoacetate, and polymerizable derivatives of diacetone, such as diacetone acrylamide and diacetonemethacrylamide, and butanone methacrylate can be used as monomers c) containing keto groups.

A very wide range of compounds capable of undergoing free radical polymerization can be used as further monomers d). These include, for example, monomers which are known to be able to improve the adhesion of the polymer films to various substrates. Examples of these are (meth)acrylates derived from alcohols or phenols having polar or reactive substituents, such as hydroxyalkyl (meth)acrylates, glycidyl (meth)acrylates, (meth)acryloyloxyalkylsilanes and (meth)acryloyloxyalkyl phosphates; or ethylenically unsaturated silanes, such as alkoxyvinylsilanes, or polymerizable ethylene urea derivatives, such as N-β-(meth)acryloyloxyethyl)-N,N′-ethyleneurea and N-(β-acrylamidoethyl)-N,N′-ethyleneurea.

For improving the soiling behavior or for increasing the resistance to chemicals, polyfunctional carboxylic acid hydrazides which contain at least two hydrazide groups, such as, for example, adipic acid dihydrazide or oxalic acid dihydrazide, isophthalic acid dihydrazide and polyacrylic acid polyhydrazide, can be added to dispersions which contain monomers c) containing keto groups.

Preferably, a molar ratio of from 0.4:0.6 to 0.6:0.4, in particular an equimolar ratio of hydrazide groups to keto groups incorporated via monomers c), is used.

A further component of the dispersion according to the invention is the selected nonionic emulsifier.

In the context of this description, aryl-substituted phenolalkyleneoxy ethers are to be understood as meaning nonionic emulsifiers which have an aryloxy group substituted by one or more aryl groups, the phenol group being substituted by (poly)alkylene oxide radicals. The (poly)alkylene oxide radical may have a free hydroxyl group at its other end; however, this is preferably etherified, in particular with an alkyl radical. The aryl substituents of the aryloxy group can be linked to the aryloxy group via covalent bonds or via a bridging group, such as an oxygen atom or an alkylene group. In the context of this description, aryloxy group is to be understood as meaning aromatic hydrocarbon radicals which have at least one phenolic hydroxyl group.

Preferred aryl-substituted phenolalkyleneoxy ethers are compounds of the formula I or II 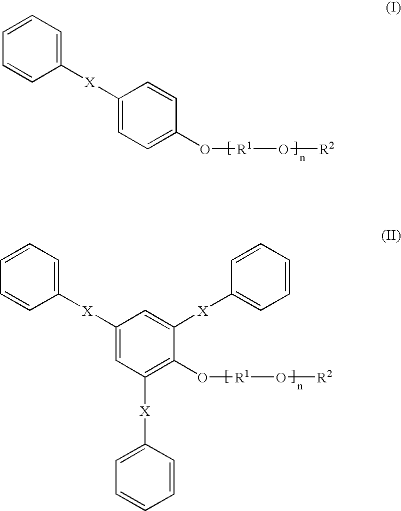
in which X is a covalent bond, oxygen or an alkylene radical, preferably a covalent bond or a —CₒH₂ₒ— radical where o is from 1 to 6, n is an integer from 1 to 40, R¹ is an alkylene or cycloalkylene radical, preferably a —CₚH₂ₚ— radical where p is from 2 to 4, and R² is hydrogen or an alkyl or cycloalkyl radical, preferably methyl or ethyl.

Emulsifiers of this type are available, for example, under the trade name Emulsogen (Clariant GmbH, Frankfurt am Main, Germany).

A particularly preferably used emulsifier of this type is an ethoxylated 2,4,6-tris(1-phenylethyl)phenol, in particular compounds having degrees of ethoxylation of from 20 to 30 ethylene oxide units per mole.

The preparation of the dispersion according to the invention can be effected by the customary emulsion polymerization processes, by emulsifying and polymerizing monomers of the first stage I and of the second stage II in succession or in separate reactors in an aqueous phase in the presence of emulsifiers, initiators and optionally protective colloids at temperatures of, for example, from 60 to 95° C. Suitable emulsifiers are aryl-substituted phenolalkyleneoxy ethers, optionally in combination with anionic or cationic emulsifiers.

The emulsion feed process in which a small amount of the first stage (monomer mixture I) is prepolymerized and then the remaining amount of monomers of the first stage and, in the case of multistage polymerization, the monomers of the second stage (monomer mixture II) in the form of an aqueous emulsion are metered in in succession is preferably employed. Alternatively, a monomer feed of monomer mixture I and monomer mixture II may also be effected in succession or in separate reactors, as well as a successive batch polymerization of monomer mixtures I and II.

The preparation of high-quality dispersions according to the present invention requires the application of the experience existing in the area of emulsion polymerization, even if it is not described here. Failure to observe the rules known to the person skilled in the art in the area of emulsion polymerization can therefore impair important properties, for example the water resistance of the dispersion film.

The dispersions should therefore not substantially exceed the usually used amounts of up to 3%, preferably of up to 2%, of ionic emulsifiers and of up to 6%, preferably of up to 4%, of nonionic aryl-substituted phenolalkyleneoxy ethers, based on the content of the polymer.

The alkylpolyglycol ethers usually used as nonionic emulsifiers, such as ethoxylation products of lauryl, oleyl or stearyl alcohol, or of mixtures such as coconut fatty alcohol; alkylphenol polyglycol ethers, such as ethoxylation products of octyl- or nonylphenol, of diisopropylphenol, triisopropylphenol or of di- or tri-tert-butylphenol; and the ethoxylation products of polypropylene oxide are either not used at all or used only in very small amounts for the purposes of this invention. These are to be understood as meaning amounts of up to 1%, based on the content of polymer.

Suitable ionogenic emulsifiers are primarily anionic emulsifiers.

These may be alkali metal or ammonium salts of alkane-, aryl- or alkylaryl sulfonates, -sulfates, -phosphates, or -phosphonates or compounds having other anionic terminal groups, it also being possible for oligo- or polyethylene oxide units to be present between the hydrocarbon radical and the anionic group. Typical examples are sodium laurylsulfate, sodium undecylglycolethersulfate, sodium octylphenolglycolethersulfate, sodium dodecylbenzenesulfate, sodium lauryldiglycolsulfate or ammonium tri-tert-butylphenolpenta- or -octaglycolsulfate.

Natural substances, such as gum arabic, starch or alginates or modified natural substances, such as methyl-, ethyl-, hydroxyalkyl- or carboxymethylcellulose, or synthetic substances, such as polyvinyl alcohol, polyvinylpyrrolidone or mixtures of such substances, are optionally used as protective colloids. Modified cellulose derivatives and synthetic protective colloids can preferably be used.

However, the use of these protective colloids is possible only to a limited extent when the described monomer systems are used, as is known to the person skilled in the art. The amounts used are frequently small, for example up to 1% by weight, and the compatibility and the method of addition must be checked from case to case. Preferably, no protective colloid at all is used during the copolymerization.

For starting and continuing the polymerization, use is made of oil-soluble and/or preferably water-soluble free radical initiators or redox systems. For example, hydrogen peroxide, potassium or ammonium peroxodisulfate, dibenzoyl peroxide, lauryl peroxide, tri-tert-butyl peroxide, azobisisobutyronitrile, alone or together with reducing components, e.g. sodium bisulfite, sulfinic acid derivatives (Rongalit), glucose, ascorbic acid and other compounds having a reducing effect, are suitable.

Furthermore, it is possible to use regulators, such as mercaptans and other customary auxiliaries known to the person skilled in the art for emulsion polymerization, so that further statements are unnecessary.

The polymerization temperature is typically in the range of from 60 to 95° C.

The end of the polymerization can be followed by a further, preferably chemical aftertreatment, in particular with redox catalysts, such as, for example, combinations of the abovementioned reducing agents and oxidizing agents, for monomer removal. Furthermore, residual monomer present can be removed in a known manner, for example by physical monomer removal, i.e. removal by distillation (in particular via steam distillation) or by stripping with an inert gas. A combination of physical and chemical methods which permits a reduction in the residual monomers to very low contents (<1000 ppm, preferably <100 ppm) is particularly efficient.

The polymer dispersions according to the invention typically have solids contents from 20 to 70% by weight, preferably from 30 to 65% by weight and particularly preferably from 40 to 60% by weight.

The polymer dispersions according to the invention are usually neutralized with aqueous ammonia, alkali metal hydroxide and alkaline earth metal hydroxide solutions and adjusted to a pH of from 6.5 to 10, preferably from 7.0 to 9.0.

On the basis of the polymer dispersions according to the invention, it is possible to prepare pigmented and unpigmented varnishes, glazes and paints for the coating of wood and other substrates. These can be prepared using the customary additives, such as wetting agents, for example aminomethyl propanol; antifoams, for example silicones and mineral oils, thickeners, such as polyacrylates or polyurethanes; waxes, such as paraffin or polyethylene; film-forming auxiliaries, for example texanol or butyldiglycol; pigments, for example titanium dioxide; fillers, dispersants, preservatives, flatting agents and other additives known to the person skilled in the art.

The polymer dispersions according to the invention are suitable for formulating pigmented and unpigmented varnishes, glazes and paints, in particular gloss paints for coating substrates of all types, in particular of wood, for example of window frames.

The present invention likewise relates to these uses.

The invention furthermore relates to the use of nonionic aryl-substituted phenolalkyleneoxy ethers in the emulsion polymerization of multistage polymers.

The following examples explain the invention without limiting it. pbw means parts by weight.

### EXAMPLE 1

In a 2 I reactor,

| | |
|---|---|
| 656.00 | pbw of water |
| 24.00 | pbw of C₁₁-alkyl ether sulfate sodium salt having about 7 |
| | ethylene oxide units, 28% strength by weight, |
| 48.00 | pbw of monomer emulsion 1 |

were heated to 80° C., and 0.60 pbw of ammonium peroxodisulfate in 16 pbw of water was added. Thereafter, the remaining monomer emulsion I and then the monomer emulsion II were metered in in the course of 3.5 hours, together with 1.8 pbw of ammonium peroxodisulfate, dissolved in 40 pbw of water. Heating was continued for a further 60 min followed by cooling. The pH was adjusted to pH=9.0 with a 25% strength ammonia solution. Thereafter, 54 pbw of a 25% strength aqueous solution of 2,4,6-tris(1-phenylethyl)phenol ethoxylate having a degree of ethoxylation of 20 and then 120 pbw of 10% strength adipic acid dihydrazide solution were added to the dispersion with stirring. The solids content of the dispersion was about 47%.

For the preparation of the monomer emulsion I,

| | |
|---|---|
| 332.00 | pbw of water |
| 25.50 | pbw of C₁₁-alkylethersulfate sodium salt having about 7 ethylene |
| | oxide units, 28% strength by weight, |
| 135.60 | pbw of methyl methacrylate |
| 578.34 | pbw of butyl acrylate |
| 14.20 | pbw of methacrylic acid |
| 7.00 | pbw of acrylic acid |
| 21.42 | pbw of diacetone acrylamide |

were stirred using a high-speed stirrer until a stable emulsion formed.

For the preparation of the monomer emulsion II,

| | |
|---|---|
| 226.50 | pbw of water |
| 17.40 | pbw of C₁₁-alkyl ether sulfate sodium salt having about 7 |
| | ethylene oxide units, 28% strength by weight, |
| 24.70 | pbw of styrene |
| 461.70 | pbw of methyl methacrylate |
| 3.30 | pbw of methacrylic acid |
| 1.50 | pbw of acrylic acid |
| 4.90 | pbw of diacetone acrylamide |

were stirred using a high-speed stirrer until a stable emulsion formed.

### COMPARATIVE EXAMPLE 1

The same preparation as in example 1, except that the addition of 54 pbw of a 25% strength aqueous solution of 2,4,6-tris(1-phenylethyl)phenol ethoxylate having a degree of ethoxylation of 20 was omitted.

### EXAMPLE 2

In a 2 I reactor,

| | |
|---|---|
| 620.00 | pbw of water |
| 22.50 | ppw of C₁₁-alkyl ether sulfate sodium salt having about 7 |
| | ethylene oxide units, 34% strength by weight, |
| 45.00 | pbw of monomer emulsion I |

were heated to 80° C., and 12 pbw of 5% strength aqueous ammonium peroxodisulfate solution were added. Thereafter, the remaining monomer emulsion I and then the monomer emulsion II, together with 62 pbw of a 5% strength aqueous ammonium peroxodisulfate solution, were metered in in the course of 3.5 hours. Heating was continued for a further 60 min, followed by cooling. The pH was adjusted to a pH=9.0 with a 25% strength ammonia solution. Thereafter, 46 pbw of 25% strength aqueous solution of 2,4,6-tris(1-phenylethyl)phenol ethoxylate having a degree of ethoxylation of 20 and then 78 pbw of a 14% strength adipic acid hydrazide solution were added to the dispersion with stirring. The solids content of the dispersion was about 47%.

For the preparation of the monomer emulsion I,

| | |
|---|---|
| 115.00 | pbw of water |
| 15.25 | pbw of C₁₁-alkyl ether sulfate sodium salt having about 7 |
| | ethylene oxide units, 28% strength by weight, |
| 101.00 | pbw of styrene |
| 50.75 | pbw of butyl acrylate |
| 335.00 | pbw of methyl methacrylate |
| 5.00 | pbw of methacrylic acid |
| 2.00 | pbw of acrylic acid |
| 5.00 | pbw of diacetone acrylamide |

were stirred using a high-speed stirrer until a stable emulsion formed.

For the preparation of the monomer emulsion II,

| | |
|---|---|
| 118.00 | pbw of water |
| 18.50 | pbw of C₁₁-alkyl ether sulfate sodium salt having about 7 |
| | ethylene oxide units, 28% strength by weight, |
| 433.25 | pbw of butyl acrylate |
| 185.00 | pbw of methyl methacrylate |
| 18.50 | pbw of methacrylic acid |
| 9.00 | pbw of acrylic acid |
| 18.50 | pbw of diacetone acrylamide |

were stirred using a high-speed stirrer until a stable emulsion formed.

### COMPARATIVE EXAMPLE 2

The same preparation as in example 2, except that the addition of 46 pbw of a 25% strength aqueous solution of 2,4,6-tris(1-phenylethyl)phenol ethoxylate having a degree of ethoxylation of 20 was omitted.

### EXAMPLE 3

### Testing of the Shear Stability

The dispersion was sprayed using an airless spray unit from Wagner, type 28-40, with the use of a spray gun from Wagner type AG09S equipped with a nozzle of 0.28 mm diameter and a prefilter having a mesh size of 0.084 mm. An entry pressure of 4.5 bar and an operating pressure of 90-100 bar were used here.

In order to test the shear stability of the dispersion the duration for which the dispersion could be sprayed before the prefilter became clogged was determined.

The following spraying times were determined:

| | |
|---|---|
| Dispersion of example 1: | >8 hours |
| Dispersion of comparative example 1: | 2 hours |
| Dispersion of example 2: | >8 hours |
| Dispersion of comparative example 2: | 2 hours |

1-21. (canceled)

22. A polymer dispersion comprising at least two copolymers A and B in a weight ratio of from 5:95 to 95:5 and a nonionic emulsifier comprising at least one aryl-substituted phenolalkyleneoxy ether, wherein the glass transition temperature T_{g} of said copolymers A and B differs by at least 10° C.

23. The polymer dispersion of claim 22, wherein said copolymers A and B are present in a weight ratio of from 30:70 to 70:30 and wherein the glass transition temperatures T_{g} of said copolymers A and B differ by at least 20° C.

24. The polymer dispersion of claim 22, wherein said copolymers A and B are multistage polymers.

25. The polymer dispersion of claim 22, wherein copolymer A has a glass transition temperature of from −60° C. to 30° C. and wherein copolymer B has a glass transition temperature of from 30° C. to 120° C.

26. The polymer dispersion of claim 25, wherein copolymer A has a glass transition temperature of from −40° C. to 20° C. and wherein copolymer B has a glass transition temperature of from 45° C. to 115° C.

27. The polymer dispersion of claim 22, wherein said copolymers A and B comprise the copolymerization product of acrylate and/or methacrylate and/or vinylaromatic monomers, wherein said monomers are present in amounts of from 70 to 99.9% by weight based on the total amount of the monomers used in the copolymerization of the respective copolymer.

28. The polymer dispersion of claim 27, wherein said copolymers A and B comprise the copolymerization product of:
a) from 85 to 99.8% by weight of acrylates of C₁ to C₂₀ alkanols, and/or methacrylates of C₁ to C₂₀ alkanols, and/or vinylaromatic monomers;
b) from 0.2 to 5% by weight of copolymerizable carboxylic acids, and/or copolymerizable carboxamides, and/or copolymerizable phosphates, and/or copolymerizable phosphonates, and/or copolymerizable sulfates, and/or copolymerizable sulfonic acids, and/or salts thereof;
c) from 0 to 10% by weight of monomers containing keto groups; and
d) from 0 to 10% by weight of other monomers.

29. The polymer dispersion of claim 28, wherein said monomers a) of said copolymers A and/or B are selected from the group consisting of acrylates of C₁ to C₂₀ monoalcohols, methacrylates of C₁ to C₂₀ monoalcohols, vinylaromatic monomers, and mixtures thereof.

30. The polymer dispersion of claim 28, wherein said monomers b) of said copolymers A and/or B are selected from the group consisting of acrylic acid, methacrylic acid, itaconic acid, acrylamide, methacrylamide, sodium ethenesulfonate, salts of sulfopropyl methacrylate, salts of acrylamido-2-methylpropanesulfonic acid, vinylphosphonate, and mixtures thereof.

31. The polymer dispersion of claim 28, wherein said monomers c) of said copolymers A and/or B are selected from the group consisting of monomers containing acetoacetoxy groups, polymerizable derivatives of diacetone, and mixtures thereof.

32. The polymer dispersion of claim 28, wherein said monomers d) of said copolymers A and/or B are selected from the group consisting of acrylates derived from alcohols or phenols having polar or reactive substituents, methacrylates derived from alcohols or phenols having polar or reactive substituents, ethylenically unsaturated silanes, polymerizable ethyleneurea derivatives, and mixtures thereof.

33. The polymer dispersion of claim 28, wherein said monomers c) of said copolymers A and/or B comprise polyfunctional carboxylic acid hydrazides containing at least two hydrazide groups.

34. The polymer dispersion of 22, wherein said at least one aryl-substituted phenolalkyleneoxy ethers have formula I and/or II 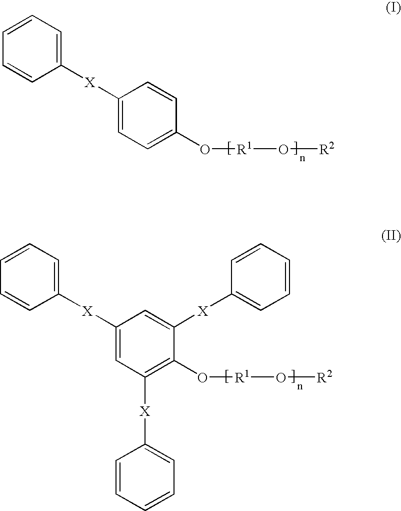
wherein
X is a covalent bond, oxygen or an alkylene radical;
n is an integer from 1 to 40;
R¹ is an alkylene or cycloalkylene radical; and
R² is H or an alkyl or cycloalkyl radical.

35. The polymer dispersion of claim 34, wherein X is a covalent bond or a —CₒH₂ₒ— radical, wherein o is an integer from 1 to 6; wherein R¹ is a —CₚH₂ₚ— radical, wherein p is an integer from 2 to 4; and wherein R² is methyl or ethyl.

36. The polymer dispersion of claim 34, wherein said at least one aryl-substituted phenolalkyleneoxy ethers is an ethoxylated 2,4,6-tris(1-phenylethyl)phenol.

37. A process for preparing the polymer dispersion of claim 22 by stepwise emulsion polymerization comprising the steps of:
i) emulsifying monomers of a monomer mixture I in an aqueous phase in the presence of emulsifiers, initiators, and optionally protective colloids and polymerizing this monomer mixture I at temperatures of from 60 to 95° C. to form a dispersion; and
ii) emulsifying monomers of a monomer mixture II in an aqueous phase in the presence of emulsifiers, initiators, and optionally protective colloids and polymerizing this monomer mixture II in the presence of the dispersion obtained in step i) at temperatures of from 60 to 95° C.;
wherein the type and amount of said monomers in monomer mixtures I and II are chosen to produce copolymers A and B in a weight ratio of from 5:95 to 95:5 and having glass transition temperature T_{g} differing by at least 10° C.

38. A process for preparing the polymer dispersion of claim 22 by stepwise emulsion polymerization comprising the steps of:
i) preparing an aqueous emulsion of a monomer mixture I;
ii) preparing an aqueous emulsion of a monomer mixture II;
iii) prepolymerizing a small amount of said monomer mixture I in the presence of emulsifiers, initiators, and optionally protective colloids;
iv) combining the remaining amount of monomer mixture I with the prepolymer of iii) to form a mixture;
v) combining monomer mixture II with the mixture of iv) to form a mixture;
vi) polymerizing the mixture of v) in the presence of emulsifiers, initiators, and optionally protective colloids at temperatures of from 60 to 95° C.;
wherein the type and amount of said monomers in monomer mixtures I and II are chosen to produce copolymers A and B in a weight ratio of from 5:95 to 95:5 and having glass transition temperature T_{g} differing by at least 10° C.

39. A process for preparing the polymer dispersion of claim 22 by separate emulsion polymerization comprising the steps:
i) preparing copolymer A by emulsifying monomers of a monomer mixture I in an aqueous phase in the presence of emulsifiers, initiators and optionally protective colloids and polymerizing this monomer mixture I in a first reactor at temperatures of from 60 to 95° C.;
ii) preparing copolymer B by emulsifying monomers of a monomer mixture II in an aqueous phase in the presence of emulsifiers, initiators and optionally protective colloids and polymerizing this monomer mixture II in a second reactor at temperatures of from 60 to 95° C.; and
iii) mixing copolymers A and B,
wherein the type and amount of said monomers in monomer mixtures I and II are chosen to produce copolymers A and B in a weight ratio of from 5:95 to 95:5 and having glass transition temperature T_{g} differing by at least 10° C.

40. Pigmented varnishes, unpigmented varnishes, glazes, and paints comprising the polymer dispersions of claim 22.

41. The polymer dispersion of claim 22, wherein said copolymers A and B are present in a weight ratio of from 40:60 to 60:40 and wherein the glass transition temperatures T_{g} of said copolymers A and B differ by at least 30° C.

42. The polymer dispersion of claim 29, wherein the monomers a) of said copolymers A and/or B are selected from the group consisting of ethyl acrylate, butyl acrylate, n-octyl acrylate, 2-ethylhexyl acrylate, methyl methacrylate, butyl methacrylate, cyclohexyl methacrylate, isobomyl methacrylate, styrene, vinyltoluene, and mixtures thereof.

43. The polymer dispersion of claim 31, wherein said monomers c) of said copolymers A and/or B are selected from the group consisting of acetoacetoxyethyl methacrylate, acetoacetoxybutyl methacrylate, acrylamidomethylacetylacetone, vinyl acetoacetate, diacetone acrylamide, diacetone methacrylamide, butanone methacrylate, and mixtures thereof.

44. The polymer dispersion of claim 32, wherein the monomers d) of said copolymers A and/or B are selected from the group consisting of hydroxyalkyl (meth)acrylates, glycidyl (meth)acrylates, acryloyloxyalkylsilanes, methacryloyloxyalkylsilanes, acryloyloxyalkyl phosphates, alkoxyvinylsilanes, N-(β-(meth)acryloyloxyethyl)-N,N′-ethyleneurea, N-(β-acrylamidoethyl)-N,N′-ethyleneurea, and mixtures thereof.

45. The polymer dispersion of claim 33, wherein said monomers c) of said copolymers A and/or B are selected from the group consisting of adipic acid dihydrazide, oxalic acid dihydrazide, isophthalic acid dihydrazide, polyacrylic acid polyhydrazide, and mixtures thereof.
